(19) United States
(12) Patent Application Publication
(10) Pub. No.: US 2008/0211220 A1
(43) Pub. Date: Sep. 4, 2008

(54) PHOTOGRAPH ALBUM WITH CAP

(75) Inventor: Tiffany BOXER, Chatsworth, CA (US)

Correspondence Address: JEFFER, MANGELS, BUTLER & MARMARO, LLP, 1900 AVENUE OF THE STARS, 7TH FLOOR, LOS ANGELES, CA, 90067, US

(73) Assignee: PIONEER PHOTO ALBUMS, INC., Chatsworth, CA (US)

(21) Appl. No.: 11/680,850

(22) Filed: Mar. 1, 2007

(51) Int. Cl. B42D 1/00

(52) U.S. Cl. 281/21.1

(57) ABSTRACT

A photo album that includes a cover having a front, a back and a spine, a plurality of bound pages that are secured between the front and back of the cover, and at least a first cap having a spine portion and at least one flange portion extending at an angle from the spine portion. The spine portion is positioned between the spine and the bound pages and the flange portion includes a back edge, a front edge and first and second side edges. Neither of the side edges are attached to any portion of the cover.

### FIELD OF THE INVENTION

The present invention concerns devices for the storage and display of photographs and the like, and more particularly to a photo album having a cap.

### BACKGROUND OF THE INVENTION

Devices for the storage and display of photographs and the like have taken many forms. One form, commonly referred to as a photograph album, comprises a plurality of bound leaves disposed within an outer cover with photographs or similar objects mounted on the two planar surfaces, or display pages, of each leaf. Due to the construction of a typical photo album, there is usually a space between the spine of the album and where the leaves are bound together. Dirt, dust and other detritus often get into this space and can damage the album.

### SUMMARY OF THE INVENTION

In accordance with an aspect of the present invention, there is provided an article that includes a cover having a front, a back and a spine, a plurality of bound pages that are secured between the front and back of the cover, and at least a first cap having a spine portion and at least one flange portion extending at an angle from the spine portion. The spine portion is positioned between the spine and the bound pages and the flange portion includes a back edge, a front edge and first and second side edges. Neither of the side edges are attached to any portion of the cover. In a preferred embodiment, at least a portion of the flange portion extends over at least a portion of the bound pages.

In accordance with another aspect of the present invention, there is provided an article that includes a cover having a front, a back and a spine, a plurality of bound pages that are secured between the front and back of the cover, and first and second caps each having a spine portion and at least one flange portion extending at an angle from the spine portion. The spine portion is adhered to an inside surface of the spine and is positioned between the spine and the bound pages and the flange portion includes a back edge, a front edge and first and second side edges. The side edges of neither of the flange portions are attached to any portion of the cover, and the flange portions each at least partially extend over at least a portion of the bound pages.

The novel features which are believed to be characteristic of the invention, together with further objectives and advantages thereof, will be better understood from the following description considered in connection with the accompanying drawings in which a presently preferred embodiment and an alternate embodiment of the invention are illustrated by way of example. It is to be expressly understood, however, that the drawings are for the purpose of illustration and description only, and are not intended as a definition of the limits of the invention.

### BRIEF DESCRIPTION OF THE DRAWINGS

FIG. 1 is a perspective view of the album with a cap exploded therefrom in accordance with a preferred embodiment of the invention;

FIG. 2 is a perspective view of the album of FIG. 1 in an open position;

FIG. 3 is a perspective view of the album of FIG. 1 with a portion of the cover cut away to show the cap; and

FIG. 4 is a perspective view of the album with a cap exploded therefrom in accordance with another preferred embodiment of the invention.

### DETAILED DESCRIPTION OF THE INVENTION

As shown in the drawings, for purposes of illustration, a preferred embodiment of the invention is a photo album or the like that includes a cap.

For exemplary purposes only, described hereinbelow is a preferred embodiment wherein the cap is used with a photo album. However, this is not a limitation on the present invention. It will be understood that the cap can be used on other types of albums or books.

It will be appreciated that terms such as “front,” “back,” “top,” “bottom,” “side,” and “below” used herein are merely for ease of description and refer to the orientation of the components as shown in the figures. It should be understood that any orientation of the album, and the components thereof described herein is within the scope of the present invention.

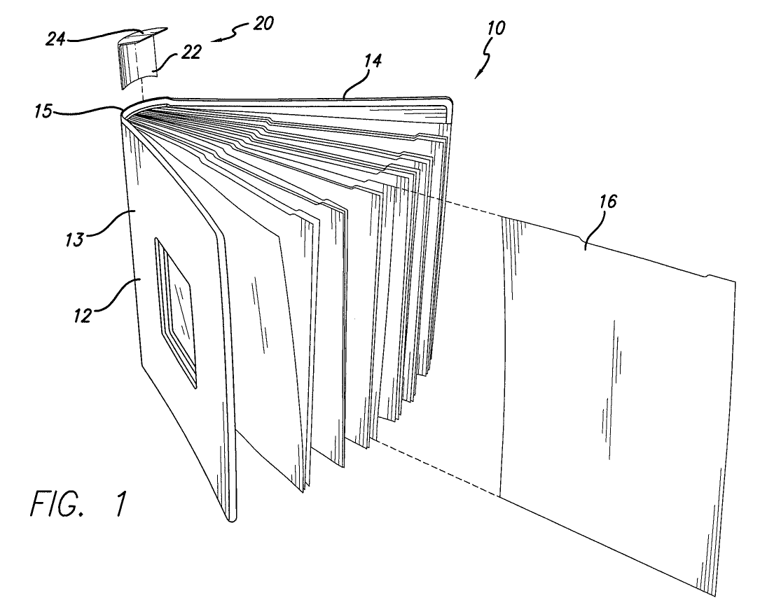

As shown in FIG. 1, a preferred embodiment of the photo album 10 of the present invention includes a cover 12 having a front 13, a back 14, a spine 15 and a plurality of pages or photo holder sheets 16. Many photo albums include removable photo sheets, as is shown in FIG. 1. Other photo albums include sheets that are permanently bound therein. It will be understood that the present invention is applicable to any type of album, book or the like.

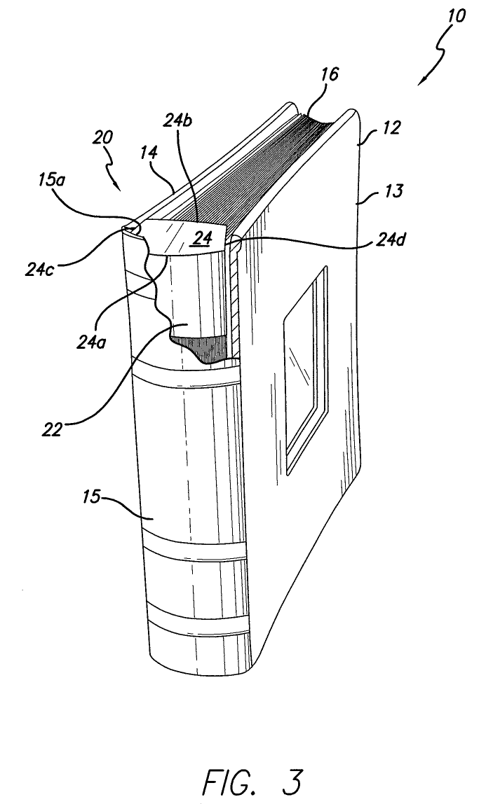

The front 13 and back 14 are joined together by the spine 15. As is shown in FIG. 1, the album includes at least one and preferably two caps 20. Cap 20 includes a spine portion 22 and a flange portion 24. The spine portion 22 is positioned between spine 15 and bound sheets 16 as is best shown in FIG. 3. Flange portion 24 preferably extends outwardly from the spine portion 22 at an approximately right angle. However, this is not a limitation on the present invention. The cap 20 may be affixed in place in any number of different ways. For example, it can be glued or otherwise adhered to an inside surface 15a of the spine 15. In another embodiment it may be adhered to the spine 15 and bound pages 16 or just the bound pages 16.

In a preferred embodiment, the cap 20 is a single piece that includes a bend or fold between the spine portion 22 and the flange portion 24. However, this is not a limitation on the present invention.

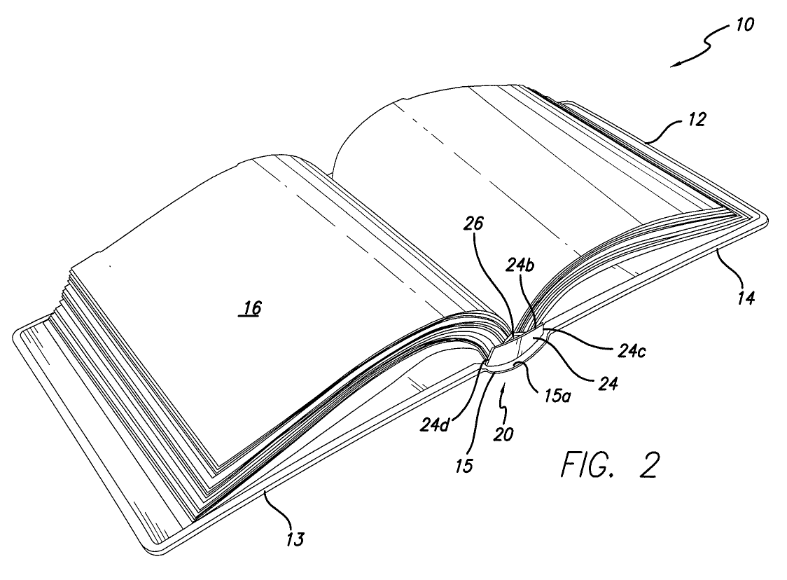

In a preferred embodiment, the flange portion 24 of cap 20 includes a back edge 24a, front edge 24b and side edges 24c and 24d. Preferably, only the back edge 20a is affixed or secured to the spine 15. As is best shown in FIG. 2, the front and side edges 24b, 24c and 24d are not affixed to any portion of the cover 12.

As is shown in FIG. 2, the flange portion 24 extends over a portion of the sheets 16. This helps keep objects from falling in to the gap 26 that is created between the spine 15 and the sheets 16 when the album 10 is in the open position. Also as shown in FIG. 2, the flange portion 24 is not attached to the front 13 or back 14 of the cover 12. This allows the album 10 to fully open and lie flat when in the open position.

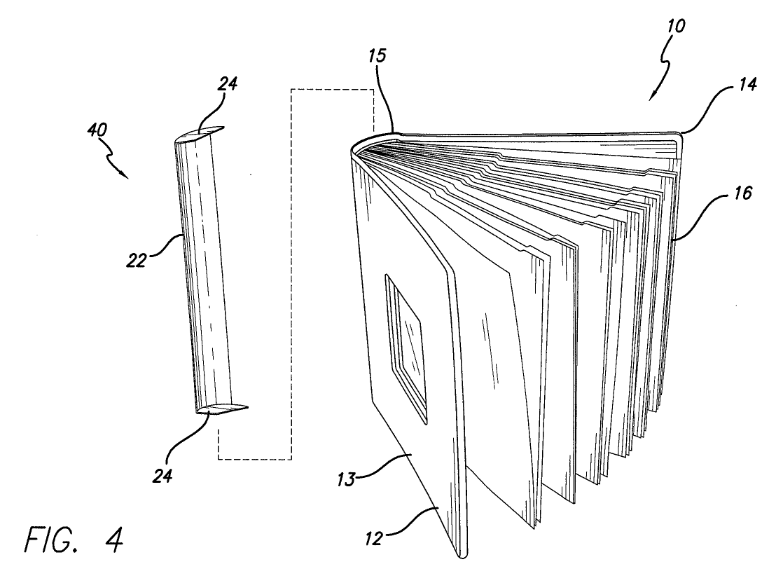

As is shown in FIG. 4, in another preferred embodiment, a cap 40 includes a spine portion 22 that extends from the top to the bottom of the spine 15 and has a flange portion 24 that extends from the opposite ends of the spine portion 22. This obviates the necessity for a two separate caps at the top and bottom of the album 10.

The embodiments described above are exemplary embodiments of a reinforcement member for a photo album. The invention is readily applicable to devices similar to photo albums, such as memory books and the like. For purposes of the claims, album shall include photo albums, memory books and the like. Those skilled in the art may now make numerous uses of, and departures from, the above-described embodiments without departing from the inventive concepts disclosed herein. Accordingly, the present invention is to be defined solely by the scope of the following claims.

What is claimed is:

1. An article comprising:
a cover having a front, a back and a spine,
a plurality of bound pages that are secured between the front and back of the cover, and
at least a first cap having a spine portion and at least one flange portion extending at an angle from the spine portion, wherein the spine portion is positioned between the spine and the bound pages, the flange portion includes a back edge, a front edge and first and second side edges, and wherein neither of the side edges are attached to any portion of the cover.

2. The article of claim 1 wherein at least a portion of the flange portion extends over at least a portion of the bound pages.

3. The article of claim 2 wherein the flange portion extends from the spine portion at an approximately ninety degree angle.

4. The article of claim 2 further comprising a second cap having a spine portion and at least one flange portion extending at an angle from the spine portion, wherein the spine portion of the first cap is positioned between the spine and the bound pages near the top of the album and the spine portion of the second cap is positioned between the spine and the bound pages near the bottom of the album, wherein the flange portion of the second cap includes a back edge, a front edge and first and second side edges and wherein the side edges of neither flange portion are attached to any portion of the cover.

5. The article of claim 4 wherein at least a portion of the flange portion of the second cap extends over at least a portion of the bound pages.

6. The article of claim 1 wherein the spine portion has opposite ends and wherein the first flange portion extends at an angle from one end of the spine portion and wherein a second flange portion extends at an angle from the opposite end of the spine portion.

7. The article of claim 6 wherein the first and second flange portions extend over at least a portion of the bound pages.

8. An article comprising:
a cover having a front, a back and a spine,
a plurality of bound pages that are secured between the front and back of the cover, and
first and second caps each having a spine portion and at least one flange portion extending at an angle from the spine portion, wherein the spine portion is adhered to an inside surface of the spine and is positioned between the spine and the bound pages, wherein the flange portion includes a back edge, a front edge and first and second side edges, wherein neither of the side edges of either of the flange portions are attached to any portion of the cover, and wherein the flange portions each at least partially extend over at least a portion of the bound pages.
